(19) United States
(12) Patent Application Publication
(10) Pub. No.: US 2011/0083073 A1
(43) Pub. Date: Apr. 7, 2011

(54) Synchronized Recording and Playback of a Plurality of Media Content

(75) Inventors: Nathan W. Atkins, Denver, CO (US); Michael Flannagan, Austin, TX (US)

(73) Assignee: CISCO TECHNOLOGY, INC., San Jose, CA (US)

(21) Appl. No.: 12/574,903

(22) Filed: Oct. 7, 2009

(51) Int. Cl. G06F 3/00

(52) U.S. Cl. 715/704

(57) ABSTRACT

An apparatus, method, and logic for the synchronized recording and playback of a plurality of media content are described herein. According to an embodiment of the present invention, first and second media content provided by at least one source are selected via a media control device configured to receive and store media content provided from a plurality of sources. Media content and format information of the selected first and second media content are retrieved from the at least one source, and the first and second media content are recorded. A master index is generated to allow synchronous playback of the first and second media content on selected presentation devices.

### TECHNICAL FIELD

The present disclosure relates generally to the synchronized recording and playback of a plurality of media content.

### BACKGROUND

Time shifting of live broadcast events that are aired at inconvenient times is a desirable capability of conventional media players (e.g., a set top box (STB), a digital video recorder (DVR), a personal computer, etc.). However, a live broadcast event may be associated with multiple feeds. When watching a live broadcast event (e.g., a motor sport race), a user can also receive real-time streaming media content of related information (e.g., a live feed of the timing and scoring information of the motor sport race) directly from the event via the Internet. For example, race cars provide telemetry and instrumentation information at the track to generate the live timing and scoring information of each car (e.g., sector times, place in the race, most recent lap times, etc.). During the race event, live video and audio (e.g., commentary, background noise of the event, music, etc.) are recorded and made available to television stations worldwide for the live broadcast of the event. In turn, these stations provide the live broadcast of the race event to their subscribers via their networks (e.g., cable, satellite, fiber, etc.). Similarly, the telemetry information (e.g., timing and scoring information) is recorded and made available to content providers (e.g., SpeedTV™) and these content providers in turn make the telemetry information available to their subscribers (e.g., via real-time streaming media over the Internet).

During the live event a subscriber can simultaneously watch the live broadcast of the event on a television and watch the live timing and scoring on a PC via a web browser. Since the subscriber is viewing the live feeds (i.e., live video and audio broadcast and the live real-time streaming media), the feeds appear to the subscriber as synchronized. Access to the live timing and scoring information during the race event enhances the subscribers experience since they have related information that is simultaneously broadcast, although not delivered through the live video feed. In order to have this enhanced experience, the subscriber needs to watch the race event during the live broadcast.

### BRIEF DESCRIPTION OF THE DRAWINGS

FIG. 1 is a block diagram of an example apparatus for synchronized recording and playback of a plurality of media content, according to an embodiment of the present invention.

FIG. 2 is a block diagram of an example media storage and synchronizing component, according to an embodiment of the present invention.

FIG. 3A is a flow diagram illustrating the manner in which synchronized recording of a plurality of media content is performed by the apparatus of FIG. 1, according to an embodiment of the present invention.

FIG. 3B is a flow diagram illustrating the manner in which selecting and scheduling of a plurality of media content to be synchronously recorded is performed by the apparatus of FIG. 1, according to an embodiment of the present invention.

FIG. 4 is a block diagram of an example user interface, according to an embodiment of the present invention.

FIG. 5 is a flow diagram illustrating the manner in which synchronized playback of a plurality of media content is performed by the apparatus of FIG. 1, according to an embodiment of the present invention.

### DESCRIPTION OF EXAMPLE EMBODIMENTS

### Overview

An apparatus, method, and logic for the synchronized recording and playback of a plurality of media content are described herein. According to an embodiment of the present invention, first and second media content provided by at least one source are selected via a media control device configured to receive and store media content provided from a plurality of sources. Media content and format information of the selected first and second media content are retrieved from the at least one source and the first and second media content are recorded. A master index is generated to allow synchronous playback of the first and second media content on selected presentation devices.

While some conventional components record both video content and data stream content, it is a fairly complicated task for a user to configure such components to synchronously record the content from the different sources. Furthermore, a fair amount of complexity and dexterity is required to replay the media content of the different sources and keep it synchronized. An aspect of the present invention is that this functionality is combined into a single solution with simple standard playback features and controls to allow a user to record and synchronously play back a plurality of media content from different sources.

A media server, according to an embodiment of the present invention, is configured to coordinate and synchronize the replay of the stored content using valid decoders to playback or distribute the content to one or more selected output devices. According to an embodiment of the present invention, a user can interact with the media server to collectively synchronize and control the playback of the content on the different output devices. For example, the user can invoke user commands (e.g., pause, fast forward, rewind, etc.) to synchronously control the replay of the media on the different output devices. As the user controls the playback, the media server controls the decoders to keep the playback of the media content synchronized. With this time-shifting ability, according to an embodiment of the present invention, a user can experience the enhanced multimedia experience when and where they want.

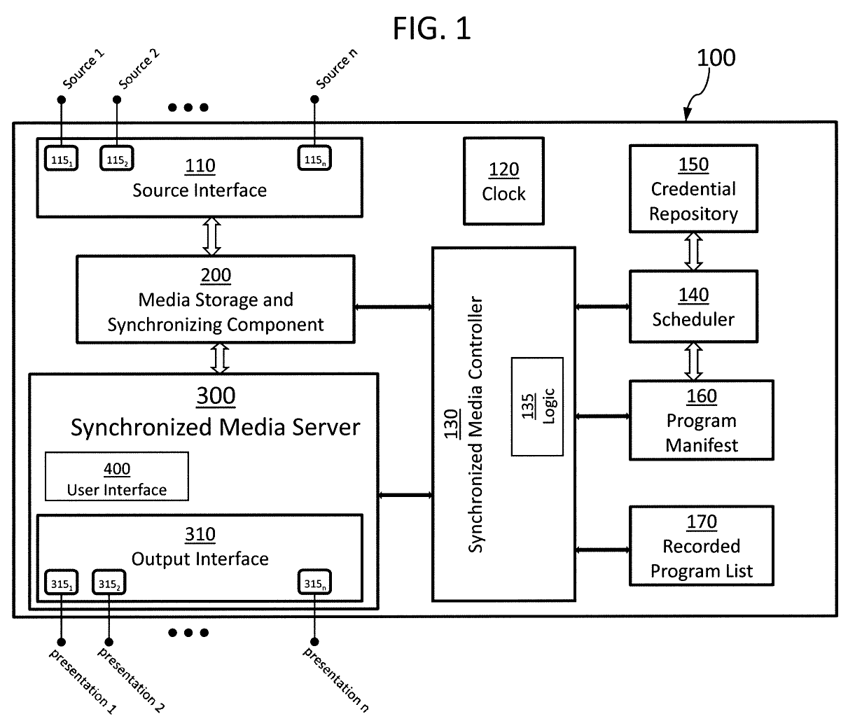

A block diagram of an example apparatus for synchronized recording and playback of a plurality of media content, according to an embodiment of the present invention, is illustrated in FIG. 1. The apparatus 100 allows an end user to schedule the simultaneous recording of media content (e.g., tracks of a live broadcast event) from at least one of the data sources for future individualized and synchronous playback on one or more of output presentation device 1 to presentation device n. The apparatus is configured to store the individual tracks in a manner that allows them to be synchronized during playback, according to an embodiment of the present invention, such that user commands (e.g., play, stop, fast forward, rewind, and slow motion) may be applied. Furthermore, according to an embodiment of the present invention, an end user may also select which tracks (e.g., media content of source 1 and source 2) are played back and on which presentation device (e.g., presentation device 1 and presentation device 2) they are respectively played. In other words, a first media content may be selected from one of source 1 to source n and a second media content may be selected from another one of source 1 to source n. In addition, the first media content may be played back on a first device selected from one of presentation 1 to presentation n and the second media content may be played back on a second device selected from another one of presentation 1 to presentation n.

Specifically, apparatus 100 comprises source interface 110, synchronized media controller 130, media storage and synchronizing component 200, and synchronized media server 300. The apparatus is configured to record a plurality of media content (e.g., tracks of a live broadcast event) received via source interface 110. Source interface 110 is configured to receive media content from source 1 to source n and comprises encoder 115₁ to encoder 115ₙ which are configured to record and format the media content (e.g., record video associated with a live broadcast event and generate index values corresponding to individual segments of the recorded video) for future synchronized playback. Media storage and synchronizing component 200 is configured to store and index the media content recorded by the encoders of source interface 110.

Synchronized media server 300 comprises output interface 310 and user interface 400 and is configured to receive recorded media content from the media storage and synchronizing component. Output interface 310 is operable to connect respective ones of decoder 315₁ to decoder 315ₙ to at least one of presentation device 1 to presentation device n during playback. The decoders are configured to decode and forward recorded media content to the respectively connected presentation device (e.g., television, personal computer, stereo system, gaming console, personal data assistant, phone, etc.). It is to be understood that presentation device 1 to device n can be connected to apparatus 100 individually or in combination (e.g., a television may be connected to the apparatus via component connections of a stereo system). Furthermore, these devices can be connected by wire or can be wirelessly connected to the apparatus.

Media server 300 is further configured to keep the media content synchronized during playback, for example, by sending time index values and synchronization command data or adjust commands to the decoders to adjust playback of one or more tracks of the media content. User interface 400 allows a user to interact with the media server to select media content to be recorded from the plurality of sources and to select recorded media content to be played back in a synchronized manner via one or more of the presentation devices. Synchronized media controller 130 is configured to control the storage and retrieval of information from program manifest database 160 in conjunction with controlling synchronized media server 300 and media storage and synchronizing component 200 of the apparatus to provide synchronous recording and playback of the media content.

Synchronized media controller 130 comprises logic 135 that is encoded in one or more tangible media for execution and, according to an embodiment of the present invention, when executed is operable to select first and second media content from at least one of source 1 to source n via scheduler 140 of media control device 100 configured to receive and store media content provided from a plurality of sources. Logic 135 when executed is further operable to retrieve media content format information of the selected first and second media content from at least one of source 1 to source n and validate any of encoders 115₁ to 115ₙ and any required credentials for the at least one source and, if required, provide any valid encoders or required credentials to receive and record the first and second media content. In addition, logic 135 when executed is operable to activate the valid encoders of encoders 115₁ to 115ₙ and supply any required credentials to the at least one source of source 1 to source n at a predetermined time to record the first and second media content and generate a master index 230 via media storage and synchronizing component 200 of media control device 100 to allow media server 300 to synchronously playback the first and second media content.

Furthermore, according to an embodiment of the present invention, logic 135 when executed is further operable to select stored first and second media content from media buffers 210₁ to 210ₙ of media storage component 200 to be synchronously replayed via media server 300, activate respective decoders of decoder 315₁ to 315ₙ to decode recorded first and second media content, and send adjust commands of master index 230 associated with the recorded first and second media content to the respective decoders of decoder 315₁ to 315ₙ to keep the media content synchronized. According to an embodiment of the present invention, logic 135 when executed is further operable to select presentation devices of presentation 1 to presentation n to respectively play the selected first and second media content. Furthermore, logic 135 when executed is operable to send adjust commands corresponding to user commands received via user interface 400 to collectively control the replay of the first and second media content. For example, when a user invokes user commands (e.g., play, stop, pause, fast forward, rewind, slow motion, etc.) via user interface 400, logic 135 is operable to send adjust commands to corresponding ones of encoders 315₁ to 315ₙ for the selected presentation devices of presentation 1 to presentation n to control the replay of each of the first and second media content in a manner consistent with the user invoked commands and such that the media content remains collectively synchronized among the respective presentation devices.

Apparatus 100 further comprises: clock 120, and scheduler 140. Clock 120 is configured to provide a global timing source to the components of the apparatus to provide synchronous recording and playback of the media content. Scheduler 140 is configured to function with program manifest database 160 and initiate recording of the media content at a scheduled time. For example, a user may select media content (e.g., tracks of a live broadcast TV event) from at least one of source 1 to source n to be recorded at a scheduled airing time of the broadcast TV event. Table 1 shows an example of recording data that may be stored in scheduler 140. Table 1 information indicates the media content tracks to be recorded (e.g., Nascar ESPN™ video and audio tracks and Nascar Live™ timing and scoring information feed) and from which source and provider the content is to be acquired (e.g., Source 1, Source 2, Comcast™, and Speed TV™).

TABLE 1
(recording data)

| Input | Provider | Media Content | Program | Date | Record Time |
|---|---|---|---|---|---|
| Source 1 | Comcast | Video track | Nascar ESPN | mm/dd/yyyy | 12:30 pm-04:00 pm |
| Source 1 | Comcast | Audio track | Nascar ESPN | mm/dd/yyyy | 12:30 pm-04:00 pm |
| Source 2 | Speed TV.com | timing and scoring | Nascar Live | mm/dd/yyyy | 12:30 pm-04:00 pm |
| | | information | | | |

Program manifest database 160 is configured to store information that indicates what media content to record and when and is further configured to store synchronization information used in the synchronization of a plurality of media content feeds during playback. In addition, the program manifest can be configured to store information indicating on which presentation devices individual tracks of the recorded media content are to be played back. Table 2 shows an example of playback data that may be stored in the program manifest database. Table 2 information indicates which media content track (e.g., Nascar ESPN™ video and audio tracks and Nascar Live™ timing and scoring information track) is to be played back on which output device (e.g., big screen TV, surround sound, and personal computer).

TABLE 2
(playback data)

| Input | Track | Output Device | Device Name |
|---|---|---|---|
| Source 1 | Video track | Presentation 3 | Big Screen TV |
| Source 1 | Audio track | Presentation 4 | Surround Sound |
| Source 2 | timing and scoring | Presentation 5 | Personal Computer |
| | information | | |

The apparatus may further comprise: credential repository 150 and recorded program list 170. Credential repository 150 stores credentials (e.g., user ids, passwords, user preferences, etc.) used to gain access to provider sites and to provide automatic selection of fields required by the content providers. Recorded program list 170 provides information indicating what media content has previously been recorded and is available for playback via media control device 100. User interface 400 is configured to read and display the information of recorded program list 170 to allow a user to view what media content is available for synchronized playback.

According to an embodiment of the present invention, a user can actively search and select media content to be recorded via the user interface 400 and scheduler 140. The scheduler is configured to operate with the user interface to allow a user to schedule recordings, select media sources, and store any credentials in credential repository 150 that are required to connect to the source at the scheduled time of recording. Scheduler 140 is further configured to connect to the providers to determine what media is available, when it is available and in what format it is available. This information is used to validate respective ones of encoders 115₁ to 115ₙ and activate them at the scheduled time of recording. In the event that a valid encoder is not found among the available encoders 115₁ to 115ₙ of apparatus 100, the scheduler is configured to request a valid encoder to be downloaded to the apparatus. Downloading of a valid encoder can be performed manually by sending a request via the user interface to instruct a user to download the valid encoder or automatically by connecting to the selected source, providing any necessary credentials and initiating download of the valid encoder.

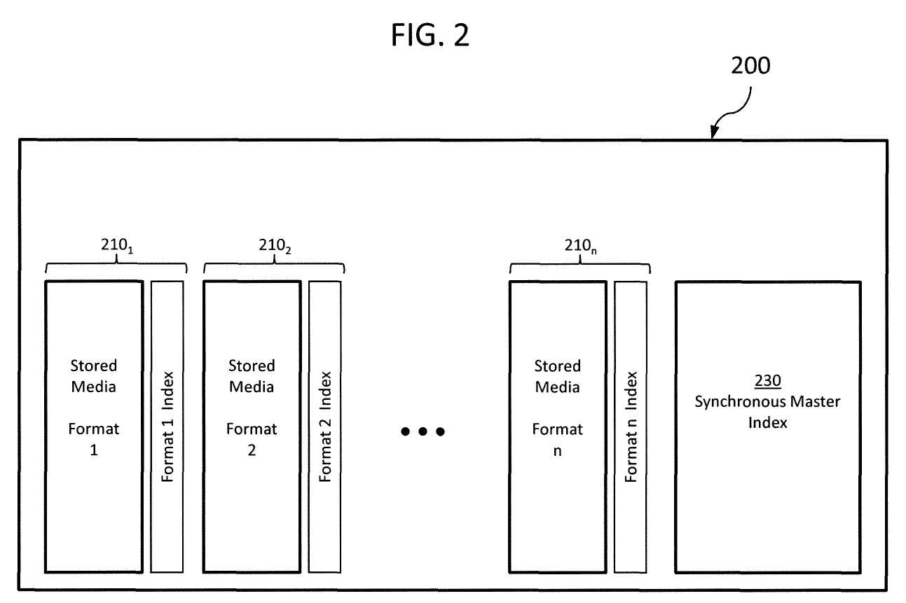

A block diagram of an example media storage and synchronizing component according to an embodiment of the present invention is illustrated in FIG. 2. Specifically, media storage and synchronizing component 200 includes stored media and index buffers 210₁-210ₙ, and synchronous master index 230. The media storage and synchronizing component is configured to generate master index 230 as the media content is recorded and indexed by the encoders and to store the recorded and indexed media content in the stored media and index buffers 210₁-210ₙ.

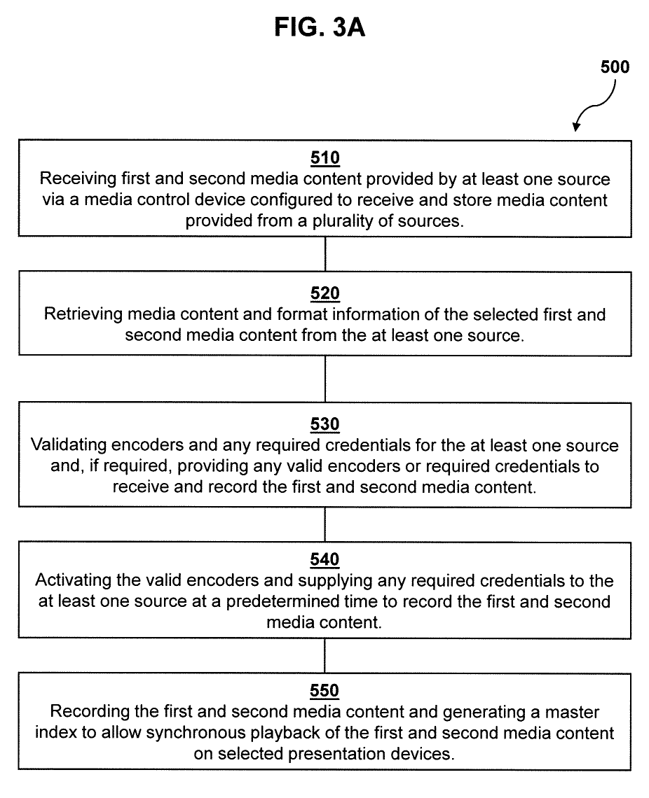

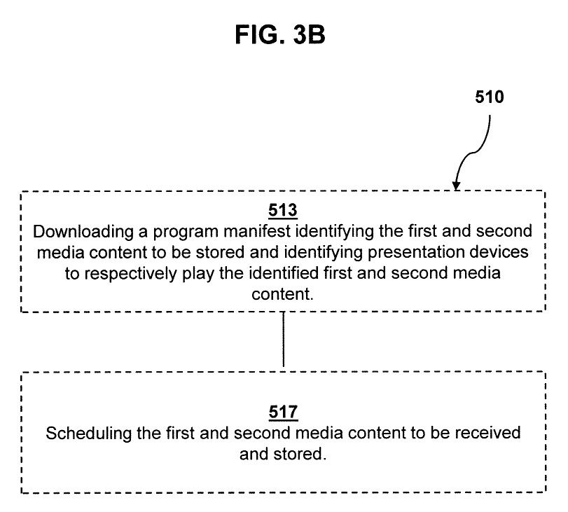

The manner in which synchronized recording of a plurality of media content is performed (e.g., by apparatus 100 of FIG. 1) is illustrated at 500 in FIG. 3A, according to an embodiment of the present invention. First and second media content is selected from at least one of source 1 to source n via scheduler 140 of a media control device 100 at step 510. According to an embodiment of the present invention, a user can select and schedule, via user interface 400 and scheduler 140 of apparatus 100, a plurality of media content (e.g., audio or video tracks of a live broadcast motor sport race, live internet feed of the timing and scoring directly from the race track, etc.) from at least one of source 1 to source n to be synchronously recorded by apparatus 100. One aspect of the present invention is that the user, via a plurality of sources, has the ability to select what media content they receive from which providers.

Examples of media content include but are not limited to: live broadcast events (e.g., sporting events, firework displays choreographed to music, etc.), streaming media (e.g., video and audio), and downloadable content (e.g., video on demand, audio recordings, documents, etc.). Source 1 to source n can be any mechanism that delivers the media content from a provider to a user. Examples of sources include but are not limited to: TV signals, cable signals (e.g., analog or digital), radio signals, optical signals, or any Internet delivery mechanisms (e.g., cable, satellite, digital subscriber line (DSL), optical carrier, etc.). Providers are entities that provide the source of the media content to be recorded. Examples of media content providers include but are not limited to: traditional television (TV) stations (e.g., network television program stations), cable and satellite TV stations (e.g., basic and subscription based program providers, pay-per-view program providers, on-demand program providers, etc.), radio stations, and Internet sites that host streaming media content (e.g., SpeedTV™, NFL Network™, YouTube™, MySpace™, Hulu™, etc.). It is to be understood this provider list is not complete and that apparatus 100 can be configured to allow for the addition of new providers and source formats through a pluggable encoder/decoder strategy.

According to an embodiment of the present invention, the recording and playback data, as shown for example in tables 1 and 2 above, can be updated in the scheduler and program manifest database via user interface 400. According to another embodiment of the present invention, the recording and playback data can be imported from an external source (e.g., a program manifest server) to program manifest database 160 (e.g., by downloading a program manifest data file via the Internet).

Media content and format information of the selected media content is retrieved from the at least one of source 1 to source n at step 520. According to an embodiment of the present invention, scheduler 140 is configured to retrieve information about the content and format of the selected media content (e.g., high definition television (HDTV) signals, moving picture expert group (MPEG-2), waveform audio format (WAV), etc.) from a content provider via at least one of source 1 to source n. For example, a source may provide program information via an interactive program guide (IPG). Furthermore, online service providers (e.g., TV Guide, MSN, etc.) provide listing of TV shows. In addition, a user may interact with the scheduler to specify criteria to be used in the retrieval of the desired media content. For example, a user may specify which source, any required credentials to access the desired media via the source, start and stop times for recording the media content, and format information of the desired media content.

As discussed above, media content can be provided via source 1 to source n from a variety of content providers. It is to be understood that the user can select multiple sources of content from a single provider or from multiple providers. Providers are capable of and will continue to offer content in multiple formats. For example, TV providers are frequently providing both standard and high-definition (HD) versions of their programming. Providers will also increasingly deliver the content both over their proprietary channels and online. Furthermore, media received from a source will typically contain format information and meta data that source interface 110 will use to select the proper decoder in order to transcode the source media content from the source format to an industry standard format. For example, a desired media content received by one of decoder 115₁ to decoder 115ₙ of the source interface can be converted from the source format (e.g., National Television System Committee (NTSC) (analog TV), Advanced Television System Committee (ATSC) or Digital Video Broadcasting (DVB) (digital TV), etc.) to MPEG.

Supported media formats include but are not limited to: RealMedia formats: (e.g., RealAudio (*.ra, *.rm), RealVideo (*.rv, *.rm, *.rmvb), RealPix (*.rp), RealText (*.rt), RealMedia Shortcut (*.ram, *.rmm)); streaming media formats: (e.g., RealTime Streaming Protocol (rtsp://), Progressive Networks Streaming Protocols (pna://, pnm://), Microsoft Windows Media Streaming Protocol (mms://), Real Scalable Multicast (*.sdp), Synchronized Multimedia Integration Language (*.smil, *.smi)); Audio media formats: (e.g., MP3 (*.mp3, *.mp2, *.mp2, *.m3u), CD Audio (*.cda), WAV (*.wav), AAC/aacPlus v1 (*.aac, *.m4a, *.m4b, *.mp4, *.acp, *.m4p), Apple Lossless, AIFF (*.aif, *.aiff), AU Audio Files (*.au), Panasonic AAC (*.acp)); Video media formats: (e.g., DVD (*.vob), Video CD (*.dat), MPEG Video (*.mpg, *.mpeg, *.m2v, *.mpe, etc.), AVI (*.avi, *.divx), MJPEG video playback from .avi files, Windows Media (*.wma, *.wmv and etc) (requires Windows Media Player 9/10), QuickTime (*.mov, *.qt) (Quick Time Player must be installed), Adobe Systems Flash (*.swf) (Flash or Shockwave Player must be installed), Flash Video (*.flv)); Playlists media formats (e.g., *.rpl, *.xpl, *.pls, *.m3u); and Graphics media formats: Bitmap (*.bmp), GIF Images (*.gif), JPEG Images (*.jpeg, *.jpg), PNG (*.png)).

Furthermore, media formats that are supported by optional plug-ins include but are not limited to: AT&T A2B (*.a2b, *.mes), Adobe Systems SVG (*.svg), Audible Audio (*.aa), Object Video (*.obv), Luidia eBeam (*.wbs), Digital Bitcasting, Envivio (*.mp4), EVEN Technologies PSI Video (*.psi, *.fxv), LearnKey RealCBT (*.lkv), Liquid Audio (*.la, *.lmsff, *.lqt *.lays *.lar *.lal), On2 VP5 (*.vp5), Netpodium Quickcast Image (*.npi), Nullsoft Streaming Video (*.nsv), LiveUpdate! Streaming MIDI files (*.mid, *.midi, *.rmi), Camtasia Video (*.camv), Ogg Vorbis/Theora (*.ogg, *.ogm), RichFX (*.vpg, *.wgs), Mode2 CDs, MIMIO Boardcast (*.mbc), BeHere iVideo 360° Movies (*.bhiv), iPIX 360° Movies (*.ipx), ScreenWatch (*.scw), Vivo Video Files (*.viv), MJuice Files (*.mjf), Blue Matter (*.bmt, *.bma), OZ.COM fluid3d, IBM EMMS (*.emm), On2 VP4 (*.vp4), On2 VP3 (*.vp3), ImagePower Motion JPEG2000 (*.jp2, *.avi), 3GP Mobile Phone Video Files (3gp), AMR Narrow Band (*.amr), Adaptive Multi-Rate|AMR Wide Band (*.amr).

Some providers require users to provide credentials (e.g., user id, password, preferences, etc.) to gain access to media content or to select desired formats of the content to be retrieved. Some of these providers may provide services that allow a media control device (e.g., apparatus 100) to determine the format and credentials required to record content without user interactions. According to an embodiment of the present invention, apparatus 100 is configured to connect to a provider via one of source 1 to source n to determine the available formats of the media content to be recorded and any credentials required by the provider to record the media content. According to one embodiment, apparatus 100 is further configured to determine the available formats and any required credentials without user interactions. It is to be understood that an end user can record any content for which he has access. This content may have restrictions (e.g., prohibiting the rebroadcasting of the content) and may require credentials to gain access (e.g., pay-per-view, premium pay channel, userid and password registration for website login, etc.).

Encoders record media content from a source onto local storage of a device. At step 530, encoder 115₁ to encoder 115ₙ and any required credentials (e.g., user id, password, etc.) for at least one of source 1 to source n, if required, are validated and provided to receive and record the first and second media content. According to an embodiment of the present invention, source interface 110, scheduler 140, and credential repository 150 of apparatus 100 function together to provide and validate any required encoder 115₁ to encoder 115ₙ and required credentials to record the selected media content from one or more of source 1 to source n. In other words, the apparatus queries the respective sources of source 1 to source n about which encoders and credentials that are required to receive and record the selected content and validates the respective encoders 115₁ to 115ₙ and credentials that are available to the apparatus. Apparatus 100 validates the respective available encoders and credentials (e.g., by comparing the version of an available encoder of source interface 110 to that of the version of the required encoder, by attempting to successfully login to a provider's site using the available credentials, etc.).

It is to be understood that encoder 115₁ to encoder 115ₙ are pluggable in the apparatus and new encoders can be added as required (e.g., in the event a new content format is developed and encoders are provided by the developer). The encoders can be custom encoders built specifically for the device, extension or wrapper around existing encoders, or existing encoders configured, according to an embodiment of the present invention, to operate with apparatus 100 and to have the required capabilities of the invention.

In the event that the apparatus determines that the available encoders or credentials are invalid (e.g., an available encoder is determined to be an outdated version, a valid encoder has not been previously acquired for a particular media content, the provider's site issues an unsuccessful login notification, etc.), apparatus 100 is configured to provide the required encoder or credentials. Examples of the apparatus providing required encoders include but are not limited to: downloading the required encoder from the source, requesting the user to install the required encoder, and requesting the user to enter valid credentials.

According to an embodiment of the present invention, in the event that the scheduler determines that an encoder is invalid or has not been acquired, scheduler 140 is configured to acquire a valid encoder. In other words, apparatus 100 is configured to verify that any of the encoders and any credentials (e.g., user id, password, etc.) that are required to access and record the selected content are valid (e.g., by querying the source to check for updated encoders and login criteria). In the case that the apparatus determines that credential repository 150 does not have access to valid credentials, the apparatus is configured to provide the valid credentials (e.g., by notifying the user to input valid credentials to allow the apparatus to gain access to the selected content). In the case that the apparatus determines that source interface 110 does not have access to a valid encoder or valid credentials, the apparatus is configured to provide the valid encoder or valid credentials (e.g., by downloading a valid encoder from the source, by notifying the user to manually install a valid encoder, requesting the user to enter valid credentials, etc.).

Valid encoders 115₁ to 115ₙ and required credentials are activated and respectively supplied to at least one of source 1 to source n at a predetermined time to record the first and second media content at step 540. According to an embodiment of the present invention, at the scheduled recording time, scheduler 140 is configured to initiate recording such that corresponding ones of valid encoders 115₁ to 115ₙ are connected to respective ones of source 1 to source n of the selected media content. Furthermore, any required credentials stored in credential repository 150 are also provided to gain access to the selected media content from the respective sources, and the encoders start recording the selected media content.

The first and second media content are recorded and synchronous master index 230 is generated via media storage and synchronizing component 200 of media control device 100 at step 550. According to an embodiment of the present invention, encoders 115₁ to 115ₙ, scheduler 140, media controller 130, and media storage and synchronizing component 200 function together to record and format the media content and provide associated index values that allow media server 300 to provide synchronized playback of the recorded media content. During recording of the media content, individual tracks of the media content are stored in the media and index buffers 210₁ to 210ₙ of the media storage and synchronizing component 200 and master index 230 is generated associating index values of the individual recorded media tracks.

According to an embodiment of the present invention, encoders 115₁ to 115ₙ are configured to record the content with an internal or external indexing mechanism such that the media server can advance or recede to specific times in each track of the recorded media content to maintain synchronization during playback. The media content may be indexed, for example, by associating time index values to portions of the recorded media content. In other words, at the scheduled time indicated by scheduler 140, apparatus 100 connects respective ones of encoders 115₁ to 115ₙ to each data source of the selected media content specified in program manifest 160 and, if necessary, provides any required credentials specified in credential repository 150 and performs any required login or starts any required PC application to begin recording the selected media content. Furthermore, respective ones of encoders 115₁ to 115ₙ of apparatus 100 provide the associated index values and generates master index 230, while storing the individual media content tracks in media and index buffers 210₁ to 210ₙ of media storage and synchronizing component 200. It is to be understood that the associated index values for the desired media content can be provided in any manner in which specific portions of the first selected media content is associated with respective portions of the second selected media content. For example, the media content and associated indexing values can be stored using a digital container or wrapper format.

A container or wrapper format is a file format, or often a stream format (the stream need not be stored as a file) whose specifications regard only the way data is stored (but not coded) within the file, and how much metadata could be, or is effectively stored, whereas no specific codification of the data itself is implied or specified. A wrapper format is, in fact, a meta-format, because it stores the real data and the information about how such data is stored within the file itself. Consequently, a program which is able to correctly identify and open a file (i.e., read a stream) written in such a format might not be able to subsequently decode the actual data stored within, because either the metadata in the wrapper file is not sufficient or the software lacks that specific decoding algorithm enrolled in the metadata to interpret the actual data the file “wraps” around.

Accordingly, a container format could, in theory, wrap around any kind of data. Although there exist a few examples of such file formats, most wrappers exist for particular data groups. This is due to the specific requirements of the desired information. The most relevant family of wrappers is, in fact, to be found among multimedia file formats, where the audio and/or video streams can effectively be coded with hundreds of different alternative algorithms, whereas they are stored in fewer file formats. In this case the algorithm (or algorithms, as in the case of mixed audio and video contents in a single video file format) used to actually store the data is called a codec (i.e., coder/decoder).

According to an embodiment of the present invention, media storage and synchronizing component 200 is configured to generate a corresponding master index 230 while recording the individual tracks of the selected media content and providing the associated index values. This allows apparatus 100 to provide synchronized playback of the stored media in multiple formats. In other words, the individual tracks are stored in a manner that allows them to be synchronized during playback with typical end user commands (e.g., play, stop, fast forward, rewind, slow motion, etc.). Furthermore, the recorded media content is stored in a manner such that individual tracks of the stored media can be played back in formats according to selected output devices. This allows a user to control what individual tracks are recorded and on which output devices the tracks are to be played. For example, a user may select a first media content to be recorded from a first source (e.g., video recorded via a cable TV channel to be played back in a first picture-in-picture (PIP) window of a television display) and may further select a second media content to be recorded from a second source (e.g., a streaming data feed of content related to the first media content via an Internet media content provider to be played back in a second picture-in-picture (PIP) window of the television display). After the media content is recorded from the different sources, the content appears as a single piece of media to the user and playback control is performed via one unified interface. Some content providers aggregate multiple tracks into a single data source (e.g., via a head end system for mass markets), an end user may be able to control which tracks he can access. However, in this case of such a data source, the end user is limited to the set of tracks aggregated by the content provider for that source. It is to be understood that, according to an embodiment of the invention, a user can record and synchronously play back any content to which he has access.

An example method of selecting and scheduling a plurality of media content to be synchronously recorded, according to an embodiment of the present invention, (e.g., by apparatus 100 of FIG. 1) is illustrated in FIG. 3B. Optionally, step 510 may further comprise step 513 for obtaining a program manifest specifying media content to be recorded and step 517 for scheduling the recording of the specified media content, according to one embodiment of the present invention. Program manifest 160 is obtained which identifies the first and second media content to be recorded via at least one of source 1 to source n and specifies which presentation devices to respectively play the first and second media content. For example, the program manifest obtained at step 513 may identify the coverage of a broadcast event (e.g., a motor sporting race) from multiple sources (e.g., coverage by different TV channels) to be recorded for simultaneous playback (e.g., picture-in-picture with multiple tracks). Furthermore, the tracks of the media content are stored such that they can be individually transcoded based on the capabilities of the specified output devices selected for each track (e.g., high definition television (HDTV), standard definition television (SDTV), personal computer display, cell phone, audio device, etc.).

Program manifests can be created via scheduler 140 or they can be downloaded from an external source (e.g., source 1 to source n) and stored in program manifest database 160 for future access. For example, a user can interact with scheduler 140 via user interface 400 to select the media content to be recorded from any of source 1 to source n and output to presentation device 1 to presentation device n for playback to create and store a program manifest in database 160. In the case of downloading a manifest, a user can, for example, interact with the user interface 400 to browse a manifest website, search for manifests of interest, select a manifest, and update access information in the manifest (e.g., cable TV channel, payment information for pay-per-view, userid and password for website access, and PCIP, username, password, application, and content selector for PC applications, etc.).

At step 517, the first and second media content is scheduled to be received and stored according to an embodiment of the present invention. For example, an end user could schedule the recording of media content specified in a program manifest obtained in step 513. The program manifest may, for example, specify a video program (e.g., a live broadcast of a motor sport race) and a related live information feed (e.g., a live feed via the interne of the timing and scoring information telecast directly from the race track) to be recorded. According to an embodiment of the present invention, apparatus 100 is configured to update the recording data in scheduler 140 based on the media content specified in the program manifest obtained in step 513. At the scheduled time, the apparatus records and indexes the individual tracks of the video program and related live information feed identified in the program manifest such that, during playback, the tracks can be individually provided to the specified presentation devices and, yet, collectively synchronized via synchronization data provided in the master index 230.

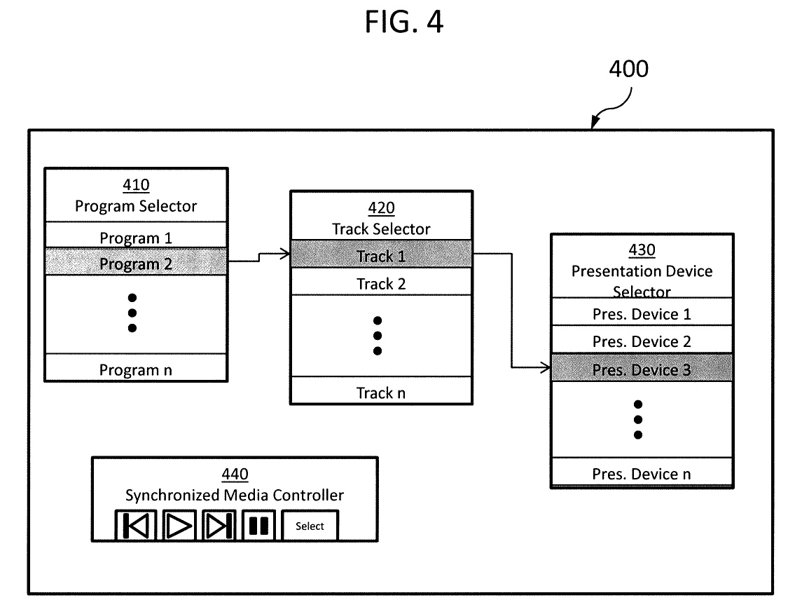

FIG. 4 is a block diagram of an example user interface, according to an embodiment of the present invention. User interface 400 comprises program selector 410, track selector 420 and presentation device selectors 430. The program selector allows a user to select a program with associated media content stored in media buffers 210₁ to 210ₙ of the media storage and synchronizing component. Track selector 420 allows a user to select a desired track of media content associated with the selected program to be played back. Presentation device selector 430 allows a user to select a presentation device connected to apparatus 100 to playback the desired track selected by the user. A user may select a presentation device for each individual track to be played back. Furthermore, apparatus 100 can be configured to specify default settings for presentation devices based on the format of the media content to be played back.

User interface 400 further comprises synchronous playback controller 440. According to an embodiment of the present invention, during playback, a user can control the playback of the tracks, individually or in combination, via synchronous playback controller 440 such that the tracks can be synchronized between the respective presentation devices. For example, a user can control the playback of the media content using user command features (e.g., play, rewind, fast forward, pause, etc.) such that the media content delivered to the respective presentation devices (e.g., big screen TV, surround sound, personal computer, etc.) are collectively synchronized. According to an embodiment of the present invention, during playback, a user can control the playback of the tracks, in combination or individually, in order to manually adjust the synchronization of the tracks. It is to be understood that user interface 400 can be accessed by the user via a user interface of any of presentation device 1 to presentation device n or may be accessed via a stand alone interface, not shown in FIG. 1, (e.g., remote, keyboard, mouse, voice activation, etc.) of the synchronized media server.

Program manifest 160 can be created to specify, inter alia, a program name, a recording time, for example, a time of live event to be broadcast or a time slot of a show with a reoccurring schedule (e.g., a show that is broadcast at the same time each week), a save duration of a program to be recorded or downloaded. Furthermore, user interface 400 and scheduler 140 can be used to interact with the schedule control access lists of the separate data sources (e.g., Cable TV interactive program guide (IPG), web sites, radio guide, pc applications, etc.) to select the recording information used by the scheduler and stored in the program manifest. Furthermore, user interface 400, scheduler 140 and credential repository 150 may work in concert to provide any access information required by a source to access the desired media content. Examples of access information that may be contained in credential repository 150 include but are not limited to: payment information required for ordering a program from Pay-Per-View TV; a website URL, username and password to gain access to the web site; and an IP address, username, password, application name, and content selector for accessing PC applications.

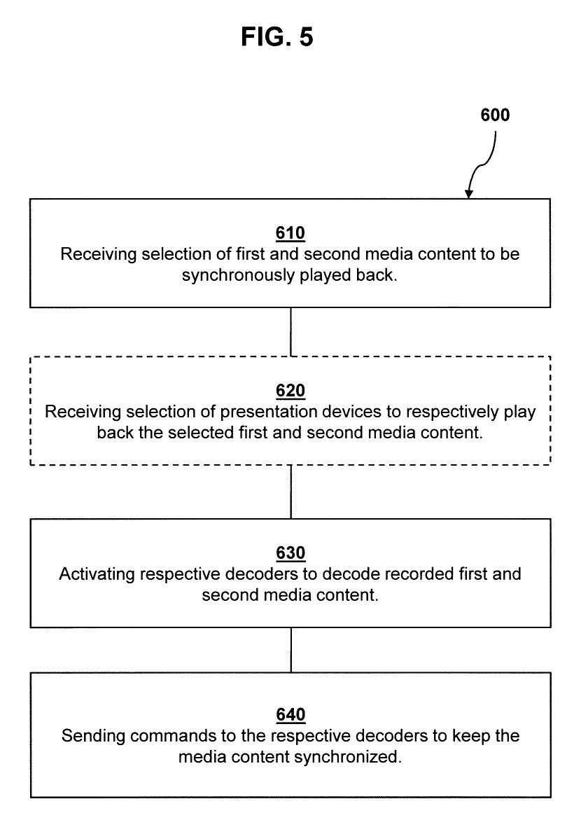

FIG. 5 is a flow diagram 600 illustrating the manner in which synchronized playback of a plurality of media content is performed by the apparatus of FIG. 1, according to an embodiment of the present invention. Desired first and second stored media content to be synchronously replayed via media server 300 is selected at step 610. Optionally, presentation devices to respectively play the selected first and second media content are selected at step 620. It is to be understood that, during playback of the selected media content, a user may change the selected presentation device on which one or more of selected media content is respectively played back. In the event that presentation devices are not selected by the user, default settings of the media server (e.g., default presentation devices based on the format of the media content) may be used to determine which presentation devices are used to play back the media content.

In the event that the desired media content is recorded live and therefore already synchronized, all desired media content tracks will be recorded from their respective sources, for example, into a single storage container. Accordingly, when these tracks are played back, they are initially synchronized. However, in the event that the desired media content is recorded from sources in which the media content is time-shifted with respect to one another, the respective tracks of the media content will initially need to be synchronized at the beginning of playback. Furthermore, if the media content of the different sources are not all delivered on a contiguous and consistent time scale, for example, due to replays or commercials, the respective tracks of the desired media content will periodically need to be synchronized. In this case the user will have to repeatedly resynchronize the different sources by adjusting the playback of the individual tracks such that they are collectively synchronized. The adjustments made by the user can be recorded as a file of synchronization data. The resulting file of synchronization information can be very elaborate and different methods can be employed to address the playback to avoid gaps in the different sources when resynchronization was taking place. For example, one source could be stretched (slowed down to take more time to playback) or compressed (sped up to take less time to playback) or it could just skip ahead. This synchronization information is stored in the master index associating adjust commands with the index values of the media content being played back.

Respective decoders to decode the recorded first and second media content are activated at step 630. During playback, media controller 130 extracts each of the selected tracks of the desired media content from media buffers 210₁ to 210ₙ and directs them to the appropriate decoder according to the selected presentation devices. The decoders convert the stored media content from the media buffers into the appropriate presentation format. Examples of common output formats include but are not limited to: audio or video signals, streaming media formats, and web content. It is to be understood that, according to an embodiment of the present invention, the user may be able to request that the content be replayed in a format that is different than the source format recorded by the device.

In addition, media controller 130 is configured to coordinate the respective decoder outputs with a transcoder of the output interface (not shown in FIG. 1) if the format of the media content to be used by a selected presentation device is different from the recorded format of the media content. For example, if a plurality of tracks of the media content are video or graphic, a composite picture-in-picture (PIP) video stream can be compiled for output to video devices (e.g., TV, monitor, cell phone, etc.). Furthermore, tracks may be removed according to the selected output device (e.g., video tracks may be removed so that only the audio tracks are delivered to an audio device (e.g., stereo, cell phone, MP3 player, etc.). In addition, tracks may be transcoded to generate appropriate formats (e.g., streaming video, web address, etc.) for specific output devices (e.g., PC, cell phone, etc.).

Time index values of master index 230 associated with the first and second media content are sent to the respective decoders to keep the decoders synchronized at step 640. Media controller 130 is configured to control the flow of the media content according to the playback synchronization data of the master index (e.g., as shown in Table 3). In other words, media controller 130 signals decoder 315₁ to decoder 315ₙ to play, pause, rewind, fast forward, stretch, or compress the respective tracks of media content according to the playback synchronization data of the master index such that the media content remains synchronized. Table 3 shows an example of synchronization data that may be stored in the master index 230.

TABLE 3
(synchronization data)

| Time Stamp | Source 1 | Source 2 | Adjust Command |
|---|---|---|---|
| 0:00 | 0:01 | 0:50 | Jump |
| 1:00 | 1:01 | 1:45 | Compress (Source 2) |
| 2:00 | 3:01 | 2:45 | Skip (Source 1) |

For example, in the case of initially synchronizing the media content, media controller 130 provides adjust commands (e.g., jump, skip, compress, etc.) with the synchronization data such that the first media content would play to a distinct location and then pause playback of the first media content (e.g., video) and play the second media content (e.g., webcast) to the same distinct location. Once the second media content plays to the same distinct location, the media controller provides adjust commands to commence synchronous playback of the first and second media content. Media controller 130 is further configured to provide the adjust commands in response to user commands (e.g., play, rewind, fast forward, pause, etc.) provided during playback of the media content. These user commands are provided via synchronous playback controller 440 of user interface 400. Media controller 130 is configured to control the flow of the first and second media content, individually or in combination, via the user commands throughout the playback of the media content to fine tune the synchronization.

For example, a user can interact with the media controller to control playback features of the media content (e.g., stop, pause, fast forward, rewind, slow motion, or play) such that the media rendered on the separate output devices remains collectively synchronized. In order to fine tune the synchronization of the media content during playback, a user may control an individual track of the media content to adjust its playback relative to the other tracks. As the user interacts with the media controller to invoke these playback features the media controller is configured to send adjust commands to the respective decoders according to the requested feature. Accordingly, the synchronization data including the adjust commands can be updated and recorded in the master index during playback of the media content. Furthermore, this recorded synchronization data can be stored in association with the selected media content via the program manifest database such that future replay of the media content is played with the fine tune synchronization provided.

Following from the example above, a user desiring to record and play back, in a synchronized manner, a recording of a live broadcast event (e.g., a motor sport race) with a recording of a separate feed of the live broadcast event (e.g., an Internet feed of the timing and scoring directly from the race track) can do so, according to an embodiment of the present invention, via apparatus 100. The user sets scheduler 140 via user interface 400 to record the video and audio portions of the motor sport race from the cable TV station to his digital video recorder (DVR) and to record the live timing and scoring feed from the station's website to his laptop PC. At the scheduled time, recording of the video and audio portions and the live timing and scoring feed of the race to their respective devices begins.

At a later and more convenient time, the user replays the recorded video and audio content to his TV and the live timing and scoring feed to web browser on his laptop PC. The user, according to an embodiment of the present invention, is able to invoke typical user commands (e.g., stop, play, pause, fast forward, rewind, slow motion, etc.) via user interface 400 to control the data feeds (i.e., video and audio content and the live scoring and timing information) to their respective presentation devices (i.e., TV and laptop PC) in manner that keeps the separate data feeds collectively synchronized. In other words, when the user plays back the video program, the synchronized recording and playback apparatus would also serve up the live information feed to the user's home network. Typical video playback controls (e.g., play, stop, fast forward, rewind, pause, slow motion, etc.) would perform the appropriate coordinated and synchronized functions on all media types. This allows the user to time shift the entire enhanced viewing experience of the race.

Another example of an event that could be recorded and synchronously played back according to an embodiment of the invention is a simulcast concert. For example, Fourth of July presentations frequently include fireworks displays choreographed to a live concert playing the 1812 Overture timed with the fireworks finale. Typically, the local TV station will show the video of the fireworks and a local radio station will broadcast the music and the booming and thudding of the fireworks in high quality sound. If a user merely records the video of this and watches it later for a recap of the big finale, he is unable to experience the synchronized radio broadcast. If the user records both the video and radio broadcast via an apparatus according to an embodiment of the present invention, however, the user will be allowed replay the recordings in a synchronized fashion at a later time to enjoy the entire enhanced experience.

Since the synchronization data is recorded in association with the selected media content, this information can be archived to external storage (e.g., via a program manifest server) and added to recorded program list 170 for future replay. For example, a user can archive the formatted media content, the master index and program manifest associated with the media content. Recorded program list 170 allows the user to view what media has been previously recorded and available for playback. Selecting content from the recorded list triggers the media server to replay the recording. In other words, after the selected media content has been recorded and indexed, a user may interact with the media server (e.g., to view a listing of recorded content from the program list) to select recorded content to be played back. The recorded program list 170 can contain data specifying the location of media content (e.g., stored in the media buffers or archived in external storage) and the associated program manifest.

The associated program manifest may contain, for example, data specifying: the name of the associated media content, the format of the individual tracks of the media content (e.g., standard DVD format, format of a synchronous recording and playback apparatus according to an embodiment of the present invention, etc.), and the selected output format of each track. In addition, this archived program manifest information can be shared (e.g., via a network including a program manifest database server) with other users who have an apparatus for synchronized recording and playback of a plurality of media content, according to an embodiment of the present invention, and who desire to view the same media content with the benefit of the synchronization of the media content provided by the initial user.

It is also conceivable that such users could 1) select a downloadable program manifest associated with desired media content, 2) download the desired media content which has been recorded to include index values, 3) connect to a streaming file including the associated master index database that is updated with the associated synchronization data in near-real time, and 4) replay the synchronized media content in near real-time with the initial user. Therefore, according to an embodiment of the present invention, a simple mechanism is provided for recording multiple information and media sources and replaying them in a synchronized manner to effectively time shift the end users complete multimedia experience. The replaying of the media can be extended to multiple locations to allow multiple users to experience the replay of the event simultaneously.

It is to be understood that apparatus 100 (e.g., including source interface 110, clock 120, synchronized media controller 130, scheduler 140, credential repository 150, program manifest 160, recorded program list 170, media storage and synchronizing component 200, media server 300, output interface 310, and user interface 400) may be embodied as hardware modules (e.g., processor, circuitry, memory, etc.), logic or software modules encoded in one or more tangible media (e.g., memory device, CD, DVD, etc.) for execution on a processor, or any combination of hardware and/or software modules.

What is claimed is:

1. A method comprising:
receiving selection of first and second media content provided by at least one source via a media control device configured to receive and store media content provided from a plurality of sources;
retrieving media content and format information of the selected first and second media content from the at least one source; and
recording the first and second media content and generating a master index to allow synchronous playback of the first and second media content on selected presentation devices.

2. The method of claim 1, further comprising:
validating encoders and any required credentials for the at least one source and, if required, providing any valid encoders or required credentials to receive and record the first and second media content; and
activating the valid encoders and supplying any required credentials to the at least one source at a predetermined time to record the first and second media content.

3. The method of claim 1, further comprising:
obtaining a program manifest identifying the first and second media content to be stored and identifying the presentation devices to respectively play the identified first and second media content.

4. The method of claim 1, further comprising:
scheduling the first and second media content to be received and stored.

5. The method of claim 1, further comprising:
receiving selection of stored first and second media content to be synchronously replayed;
activating respective decoders to decode recorded first and second media content; and
sending commands to the respective decoders to keep the media content synchronized.

6. The method of claim 5, further comprising:
receiving selection of the presentation devices to respectively play back the selected first and second media content.

7. The method of claim 5, wherein sending commands comprises:
sending user commands via a user interface to collectively control the replay of the first and second media content.

8. The method of claim 7, wherein sending user commands includes commands selected from the group including: play, stop, pause, fast forward, rewind, and slow motion.

9. A media control device comprising:
a source interface connected to a plurality of sources and configured to receive and decode at least first and second media content provided from at least one of the sources;
a synchronized media controller configured to retrieve media format information of the first and second media content from the at least one source; and
a media storage and synchronizing component configured to index and store the first and second media content, the media storage and synchronizing component being configured to generate a master index to allow the media server to synchronously playback the first and second media content on selected presentation devices.

10. The media control device of claim 9, wherein the synchronized media controller is further configured to validate encoders and required credentials for the at least one source and, if required, provide and activate any valid encoders or provide and supply any required credentials to the at least one source at a predetermined time to receive and record the first and second media content.

11. The media control device of claim 9, further comprising:
a program manifest database containing program manifest data identifying the first and second media content to be recorded and identifying the presentation devices to respectively play the identified first and second media content.

12. The media control device of claim 9, further comprising:
a scheduler configured to schedule the recording of the first and second media content.

13. The media control device of claim 9, further comprising:
a media server including an output interface connected to a plurality of presentation devices to synchronously replay the first and second media content on at least one of the presentation devices, wherein:
the master index contains commands associated with the recorded first and second media content; and
the synchronized media controller is further configured to activate respective decoders to decode the first and second media content and send the commands of the master index to the respective decoders to keep the media content synchronized.

14. The media control device of claim 13, wherein the media server comprises a user interface configured to allow a user to select the at least one presentation device.

15. The media control device of claim 13, wherein:
the media server comprises a user interface configured to send user commands to the synchronized media controller; and
the synchronized media controller is responsive to the user commands to provide commands to the respective decoders to collectively control the replay of the first and second media content.

16. The media control device of claim 15, wherein the user commands are selected from the group including: play, stop, pause, fast forward, rewind, and slow motion.

17. The media control device of claim 13, further comprising:
a credential repository to store data to gain access to the at least one source.

18. The media control device of claim 13, further comprising:
a recorded program list to store data indicating what previously recorded media content is available to be synchronously played back.

19. Logic encoded in one or more tangible media for execution and when executed operable to:
receive selection of first and second media content, provided by at least one source, via a media control device configured to receive and store media content provided from a plurality of sources;
retrieve media content format information of the selected first and second media content from the at least one source; and
record the first and second media content and generate a master index to allow synchronous playback of the first and second media content on selected presentation devices.

20. The logic of claim 19, further operable to:
validate encoders and any required credentials for the at least one source and, if required, providing any valid encoders or required credentials to receive and record the first and second media content; and
activate the valid encoders and supplying any required credentials to the at least one source at a predetermined time to record the first and second media content.

21. The logic of claim 19, further operable to:
receive a selection of stored first and second media content to be synchronously replayed;
activate respective decoders to decode recorded first and second media content; and
send commands to the respective decoders to keep the media content synchronized.

22. The logic of claim 21, further operable to:
receive selection of presentation devices to respectively play back the selected first and second media content.

23. The logic of claim 21, wherein said sending of commands comprises:
sending user commands via a user interface to collectively control the replay of the first and second media content.
